(19) United States
(12) Patent Application Publication
(10) Pub. No.: US 2023/0183879 A1
(43) Pub. Date: Jun. 15, 2023

(54) Anti-Corrosive Oil-Impregnated Nanoporous Oxide Coating For Stainless Steel

(71) Applicant: THE TRUSTEES OF THE STEVENS INSTITUTE OF TECHOLOGY, Hoboken, NJ (US)

(72) Inventors: Chang-Hwan Choi, Tenafly, NJ (US); JungHoon Lee, Busan (KR)

(73) Assignee: THE TRUSTEES OF THE STEVENS INSTITUTE OF TECHNOLOGY, Hoboken, NJ (US)

(21) Appl. No.: 17/971,328

(22) Filed: Oct. 21, 2022

Related U.S. Application Data
(63) Continuation of application No. PCT/US2021/028982, filed on Apr. 23, 2021.
(60) Provisional application No. 63/015,360, filed on Apr. 24, 2020.

(51) Int. Cl. C25D 5/48; C09D 5/08; C09D 127/18; C25D 11/02; C25F 3/24; C25D 5/36

(52) U.S. Cl. CPC C25D 5/48; C09D 5/08; C09D 127/18; C25D 11/02; C25F 3/24; C25D 5/36

(57) ABSTRACT

A method for creating oil-filled porous anodic oxide coatings for stainless steel is disclosed. The coating has anti-corrosion and omniphobic properties to resist both atmospheric conditions, or other conditions with exposure to vapor, and wet conditions, in which the coating is exposed to and/or immersed in liquid. The anodic oxide coating of the present invention can be made by the steps of cleaning and/or electropolishing a steel substrate, applying anodic oxidation to the steel substrate, washing the steel substrate in an organic solvent, and annealing the substrate at high temperature. To fill the porous coating with an oil, a solvent exchange method may be applied.

### CROSS-REFERENCE TO RELATED APPLICATION

This application is a continuation of International Patent Application No. PCT/US2021/028982, filed Apr. 23, 2021, which claims priority to U.S. Provisional Patent Application No. 63/015,360, filed Apr. 24, 2020, the entire disclosure of each of the foregoing applications being incorporated herein by reference for all purposes.

### STATEMENT OF GOVERNMENT INTEREST

This invention was made with government support under Award No. N00014-14-1-0502 awarded by the Office of Navy Research (ONR) of the United States Navy. The government has certain rights in the invention.

### FIELD OF THE INVENTION

The present invention relates to anti-corrosion coatings. More specifically, it relates to coatings that can be applied to stainless steel and other hard metals to provide insulation against deleterious operating conditions.

### BACKGROUND OF THE INVENTION

Corrosion causes many serious problems that limit the satisfactory operating lifetime of metallic materials. Therefore, corrosion-resistant surfaces for metallic materials are of great importance in a broad range of engineering systems and applications. For decades, various strategies have been employed to prevent the corrosion of metallic materials in service environments. For example, thin organic (or polymer) coatings, such as simple painting, spraying and shrink-wrapping, have proven convenient and are widely used ways to form passive layers on metals. Although these organic coatings inhibit the mass transfer of corrosion reactants (e.g., water, oxygen and chloride), they can be easily degraded by UV exposure and temperature changes. Such degradation allows the corrosion reactants to be transported to the metal/polymer interface, resulting in crevice corrosion and delamination of the coatings from metallic surfaces.

Hard ceramic protective layers produced by thermal spraying and passive oxide layers produced by sol-gel coatings have also been employed as anti-corrosive measures for metals. However, inhomogeneous coatings having surface cracks due to poor adhesion is still a hurdle to be overcome.

Lubricant-impregnated surfaces are one approach to achieve liquid-repellent properties, which technique has also been studied for use as a corrosion-resistant coating for metals. Due to the mobile and low surface tension of the lubricant layer, most liquids, including water and aqueous corrosive media, can effectively be repelled, resulting in the protection of the metal surface against corrosive liquids.

Since lubricant-infused porous surfaces were first introduced as a potential solution, they have aroused significant attention in a wide range of applications to solve various problems on solid surfaces. However, prior approaches mainly used interconnected porous structures. These structures have proven prone to lose lubricant out of the pores, making such treatments ineffective in real applications with practical limitations, such as longevity and robustness of the surfaces.

Thus, disconnected porous structures are highly demanded to achieve lubricant-infused porous surfaces with great retentivity of the lubricant. However, proper material processing techniques and their applications to oil-impregnated porous surfaces need to be developed further.

Stainless steel is arguably the most popular and essential metal material employed in many applications that are subject to various wet and dry conditions. Thus, the development of material processing technology to fabricate durable, nanoporous oxide structures on stainless steel is of great significance to surface finishing and functionalization.

While some developments pertaining to lubricant-impregnated, nanoporous oxide coatings have been realized for light metals, such as aluminum (see, for example, U.S. Patent Application Publication No. 2019/0242026, such an approach cannot be effectively applied to hard metals, such as stainless steel, since it is challenging to create a well-regulated and durable nanoporous oxide layer on a stainless steel surface using previously-established electrochemical methods.

Previously, electrodeposition of tungsten trioxide (WO₃) on steel was employed to realize a hierarchically-structured surface for oil impregnation, and the oil-impregnated tungsten trioxide surface was investigated for application to anti-biofouling for steel. Electrochemically-etched microscale pores have also been employed to realize an oil-impregnated surface on stainless steel.

### SUMMARY OF THE INVENTION

A novel method is presented for fabricating a highly stable, oil-impregnated nanoporous oxide surface for stainless steel, which is one of the most essential metallic substrates for various engineering systems and components, as an omnicorrosion resistant coating (i.e., corrosion protection against corrosive media in both liquid and vapor phases) with great durability.

Stainless steel can be anodized in ethylene glycol-based solution to create a nanoporous oxide film configured for the impregnation of the corrosion-protective lubricant oil. However, the as-anodized structure of stainless steel is soluble in water such that the film can be easily removed by moisture and/or condensation of water. This instability issue is resolved by thermal annealing, which makes the film irremovable with water. This modification of the film by annealing enables the formation of a stable anodic layer on stainless steel.

In the present invention, the anodizing process for stainless steel is adapted to realize a durable oxide layer with disconnected high-aspect-ratio and dead-end nanoscale pore structures, which helps attain sustainable oil retention and support the omniphobic and omnicorrosion-resistant properties with great durability.

The process of the present invention was developed to realize omniphobic properties and to improve the corrosion resistance of stainless steel by creating and employing an oil-impregnated nanoporous oxide layer on the stainless steel surface. Similar approaches can also be applied to other ferrous alloys used commercially to achieve similar anti-corrosion benefits.

An oil-impregnated porous layer has little chance to absorb corrosive media, so that such a layer on metallic material can exhibit robust anti-corrosion performance. Even when the anodic oxide layer is physically damaged, the liquid oil can flow and cover the damaged area so that the exposure of the stainless-steel metallic surface to outer environments can be minimized. Since oil has high water-repellency, the treated surface can allow other benefits such as drag reduction, self-cleaning, anti-icing, and anti-fouling.

The oil-impregnated oxide surfaces of the present invention provide an exceptional anti-corrosion property not only against the liquid phase, but also against the vapor phase, an improved result compared to the other types of water-repelling surfaces (e.g., superhydrophobic surfaces). The demonstrated strategy holds great promise for realizing a durable and robust corrosion protection scheme for hard metals in general, but for stainless steel, in particular, especially in real applications, such as chemical plants, heat exchanger systems, seawater desalination, and marine systems, where the corrosive media can be transported via both liquid and vapor phases.

Generally speaking, the present invention produces a sustainable metal surface with corrosion-resistance, wear-resistance, drag-reduction, anti-icing and anti-fouling properties. The coating technique of the present invention can also be applied to many systems and components made of stainless steel used in military applications, such as naval ships, submarines, torpedoes, tanks, and aircraft. It can also be used in commercial products such as automobiles, oil/gas pipelines, and marine structures

In an embodiment, the anodic oxide coating of the present invention can be made by the steps of cleaning and/or electropolishing a steel substrate, applying anodic oxidation to the steel substrate, washing the steel substrate in an organic solvent, and annealing the substrate at high temperature. To fill the porous coating with an oil, a solvent exchange method may be applied, such as one involving the steps of applying polytetrafluoroethylene (PTFE, commonly referred to by the trademark Teflon®) coating on the nanoporous anodic oxide surface, filling the pores with at least one alcohol component, such as ethanol, replacing the ethanol with an oil solvent and replacing the solvent with oil.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a more complete understanding of the present invention, reference is made to the following detailed description of various representative embodiments considered in conjunction with the accompanying drawings, in which:

FIG. 1A is a series of schematic representations of the various processing steps employed to achieve the oxidation of stainless steel AISI 304;

FIG. 1B is an optical image of as-anodized stainless steel before (left) and after (right) rinsing with water;

FIG. 1C is an optical image of anodized stainless steel with annealing before (left) and after (right) rinsing with water;

FIGS. 1D-1G are XPS spectra for as-anodized stainless steel and that with annealing for: O 1 s, F 1 s, Fe 2p3/2 and Cr 2p3/2, respectively;

FIG. 1H is the XPS spectra of FIG. D, modified to show relevant peaks;

FIG. 1I is the XPS spectra of FIG. E, modified to show relevant peaks;

FIGS. 2A-2D depict SEM images of nanoporous oxide layers of stainless steel anodized under 40, 60, 80 and 100 V, respectively, in ethylene glycol-based electrolyte, showing both top (left) and cross-sectional (right) views;

FIG. 2E is a graph illustrating indentation hardness and modulus of the anodized nanoporous oxide layers of stainless steel with annealing;

FIGS. 3A and 3B are bar graphs illustrating contact angle hysteresis (CAH) of water and hexadecane droplets (˜5 μl), respectively, on electropolished stainless steel (PS), PTFE-coated electropolished stainless steel (T-PS), anodized stainless steel (AS), and PTFE-coated anodized stainless steel (T-AS), without and with oil impregnation (Krytox GPL 100);

FIGS. 3C and 3D are a series of images showing sliding angles of water and hexadecane droplets (˜5 μl), respectively on surfaces;

FIG. 4A is a graph illustrating sliding velocity of water droplets (˜5 μl) continuously deposited on oil-impregnated PTFE-coated electropolished stainless steel (T-PS) and PTFE-coated anodized stainless steel (T-AS) surfaces, with inset images of schematic procedure and sliding path);

FIG. 4B is a series of images illustrating a wettability test of the oil-impregnated PTFE-coated anodized stainless steel (O-T-AS) by applying an external jet flow of water;

FIG. 5A is a series of images showing a self-healing test of the oil-impregnated (Krytox GPL 100) PTFE-coated anodized stainless steel (O-T-AS), showing a SEM image of a surface following a scratch from a sharp razor blade (top) and sequential images of a sliding water droplet over the scratch;

FIG. 5B is a graph depicting potentiodynamic curves of electropolished (PS), anodized (AS), PTFE-coated anodized (T-AS), scratched PTFE-coated anodized (S-T-AS), oil-impregnated (Krytox GPL 100) PTFE-coated anodized (O-T-AS) and scratched oil-impregnated PTFE-coated anodized (S-O-T-AS) stainless steel in 1M HCl solution;

FIG. 5C is a bar graph depicting estimated corrosion current density (I_{corr}) and potential (E_{corr}) for the potentiodynamic polarization curves of FIG. 5B;

FIG. 6A is a series of optical (left) and SEM (right) images of electropolished (PS), PTFE-coated electropolished (T-PS), FDTS-coated electropolished (F-PS), anodized (AS), PTFE-coated anodized (T-AS) and oil-impregnated (Krytox 1506) PTFE-coated anodized (O-T-AS) stainless steel before exposure to HCl gas for 5 hr;

FIG. 6B is a series of optical (left) and SEM (right) images of electropolished (PS), PTFE-coated electropolished (T-PS), FDTS-coated electropolished (F-PS), anodized (AS), PTFE-coated anodized (T-AS) and oil-impregnated (Krytox 1506) PTFE-coated anodized (O-T-AS) stainless steel after exposure to HCl gas for 5 hr;

FIG. 6C is a bar graph illustrating the chemical compositions (obtained using EDS) of oxygen on the stainless steel surfaces of FIGS. 6A and 6B after the exposure to HCl gas for 5 hr;

FIG. 6D is a bar graph illustrating chemical compositions (obtained using EDS) of chlorine on the stainless steel surfaces of FIGS. 6A and 6B after the exposure to HCl gas for 5 hr;

FIG. 6E is a bar graph illustrating mass changes of the specimens of FIGS. 6A and 6B during the exposure to HCl gas;

FIG. 7 is a schematic diagram showing exposure to corrosive media of a steel oxide layer with impregnated lubricant (right) and without impregnated lubricant (left); and

FIG. 8 is a schematic image showing a corrosion testing setup and a photograph of same inset therein.

### DESCRIPTION OF EMBODIMENTS OF THE INVENTION

Various embodiments of the present invention are disclosed herein; however, it is to be understood that the disclosed embodiments are merely illustrative of the invention that can be embodied in various forms. In addition, each of the examples given in connection with the various embodiments is intended to be illustrative, and not restrictive. Further, the figures are not necessarily to scale, and some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or disclosed subject matter is intended to be construed as not being limited to any exemplary embodiments set forth herein, it being understood that such exemplary embodiments are provided merely to be illustrative. Among other things, for example, subject matter may be embodied as methods, devices, components, or systems. The following detailed description is, therefore, not intended to be taken in a limiting sense.

Throughout the specification, terms may have nuanced meanings suggested or implied in context beyond an explicitly stated meaning. Likewise, the phrase “in one embodiment” as used herein does not necessarily refer to the same embodiment and the phrases “in another embodiment” and “other embodiments” as used herein do not necessarily refer to a different embodiment. It is intended, for example, that covered or disclosed subject matter includes combinations of the exemplary embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Turning now to the present invention, it involves a novel material processing technique for stainless steel that produces oil-impregnated nanoporous oxide coatings directly on the stainless steel surfaces. In an embodiment, the present invention employs an anodizing technique to create a durable nanoporous oxide layer on stainless steel substrates and then impregnates the nanopore structures with water-repelling oil so that the oil is stably retained within the nanopore structures to thereby prevent the penetration of corrosive media, both liquid and vapor phases, with great sustainability.

The present invention can be used as a surface treatment method, which improves surface properties of stainless steel or allows new surface functionalities. For example, when the treated surface is exposed to external environments, the surface treatment method of the present invention can protect the inner material of stainless steel from being corroded and degraded by the external environment. The present invention uses an oil-impregnated nanoporous oxide layer for anti-corrosion, which is directly grown on the original stainless steel surface by using an electrochemical anodizing method followed by thermal treatment. One implementation is to directly create a nanoporous oxide layer on the stainless steel substrate and fill corrosion-resistant liquid oil into the nanopores so that the retained oil layer on the surface efficiently and effectively insulates the substrate from outer corrosive environments (e.g., salty water and atmosphere). Since the oil has repellency to water-based liquid and vapor, corrosive media from liquid and vapor cannot penetrate into the pores of the oxide layer on the stainless steel surfaces so that the corrosion of the stainless steel substrate under the oxide layer is significantly impeded. The annealing step employed in accordance with the present invention allows for the formation of a stable oxide layer following the anodizing of the stainless steel. These steps cooperate to form a stable oxide layer on the stainless steel surfaces, resulting in a great stability and capability to retain the impregnated oil within the oxide nanostructures.

In an embodiment, the anodic oxide coating achieved in accordance with the present invention can be made by the steps of cleaning and/or electropolishing a steel substrate, applying anodic oxidation to the steel substrate, washing the steel substrate in an organic solvent, and annealing the substrate at high temperature. To fill the porous coating with an oil, a solvent exchange method may be utilized, such as one involving the steps of applying a polytetrafluoroethylene (PTFE) coating on the nanoporous anodic oxide surface, filling the pores with at least one alcohol component such as ethanol, replacing the ethanol with an oil solvent and replacing the solvent with oil.

It should be appreciated that other types of coatings can be applied to the nanoporous anodic oxide surfaces with the object of making such surfaces hydrophobic and oleophilic (i.e., having a low chemical affinity to water, but having high chemical affinity to oil. Likewise, although ethanol is used for exemplary purposes, other solutions with low surface tensions and Henry's constants (e.g., methanol, isopropyl alcohol, etc.) can also be used. Instead of PTFE, treatment with alternative hydrophobic surface treatments can be used, as long as the chemical affinity between the hydrophobic treatment chemical and oil (i.e., lubricant) is stronger than that of the hydrophobic treatment chemical and water.

Structurally, the aforementioned process results in a durable oxide layer with disconnected high-aspect-ratio and dead-end nanoscale pore structures. Such nanoporous geometry contributes to sustainable oil retention and the desired omniphobic and omnicorrosion-resistant properties, while providing great durability.

It has been demonstrated that the hydrophobized nanoporous oxide layer on stainless steel effectively retains the oil (e.g., fluorocarbon lubricant) on the surface by strong capillary action, while showing omniphobicity. Moreover, the oil-impregnated layer on the stainless steel substrate significantly enhances the corrosion resistance of the stainless steel, with superior durability and self-healing capability against both liquid and vaporized corrosive media.

Further embodiments of the present invention are now presented with reference to the following examples.

### Example 1

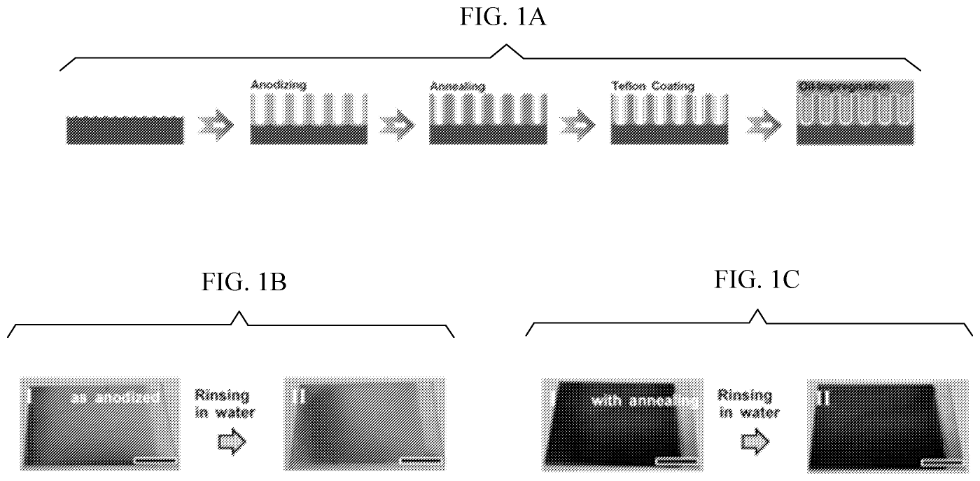

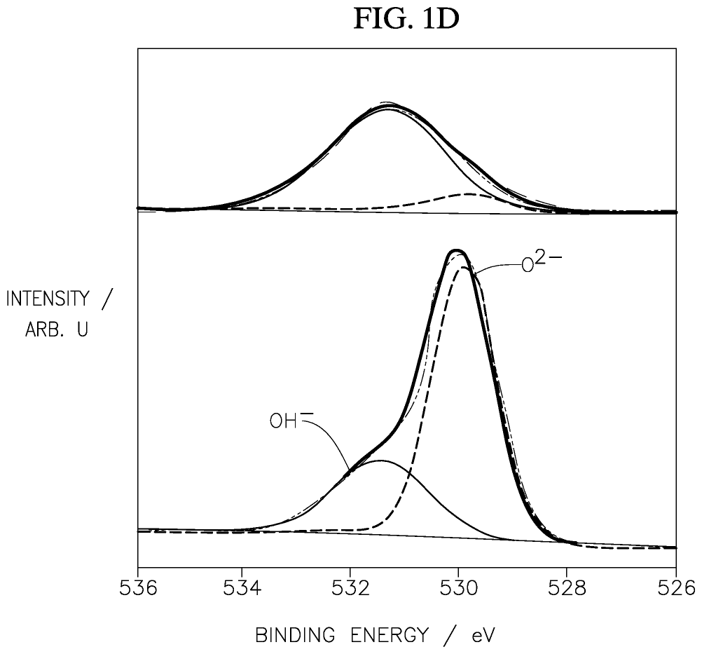

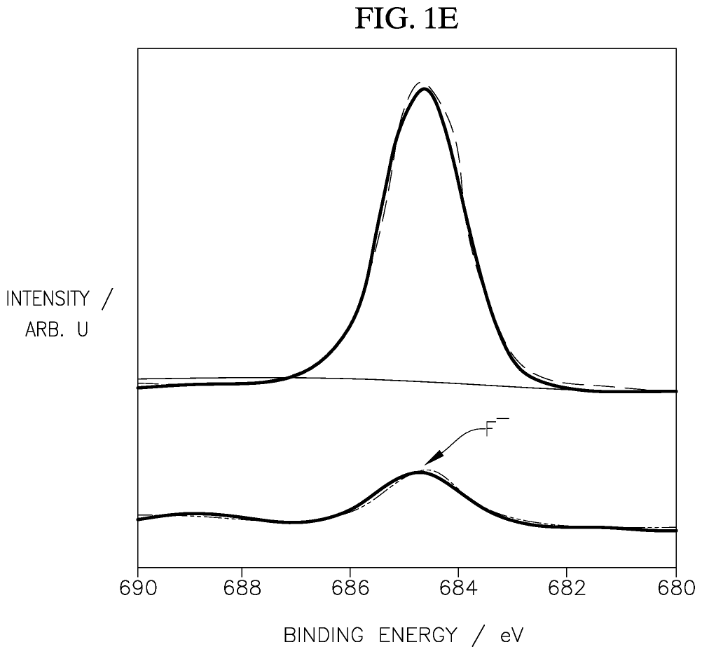

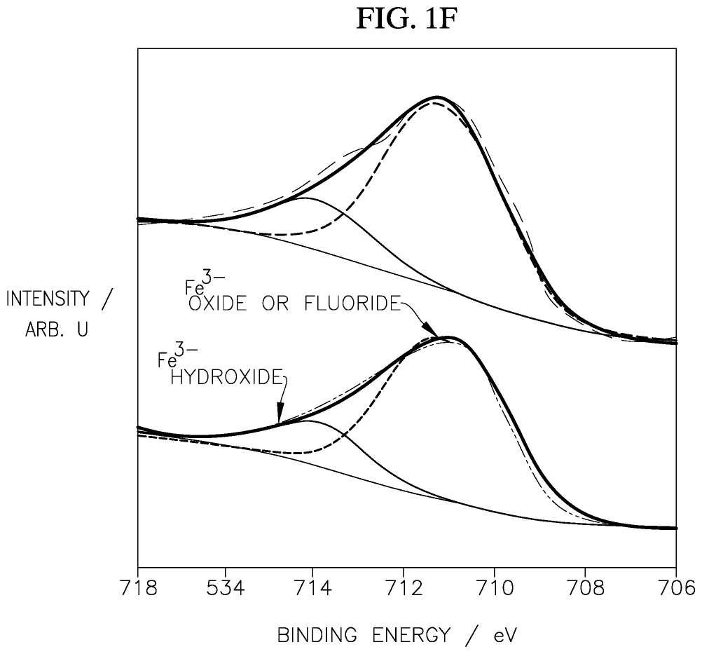

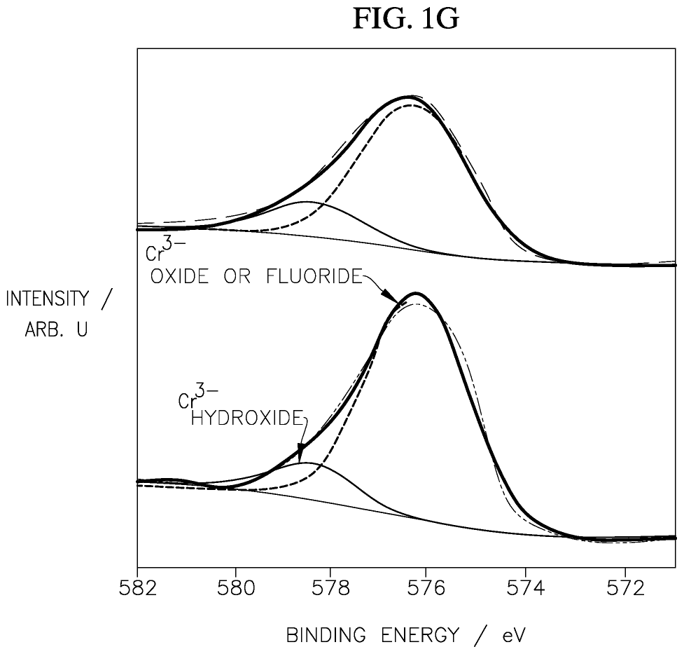

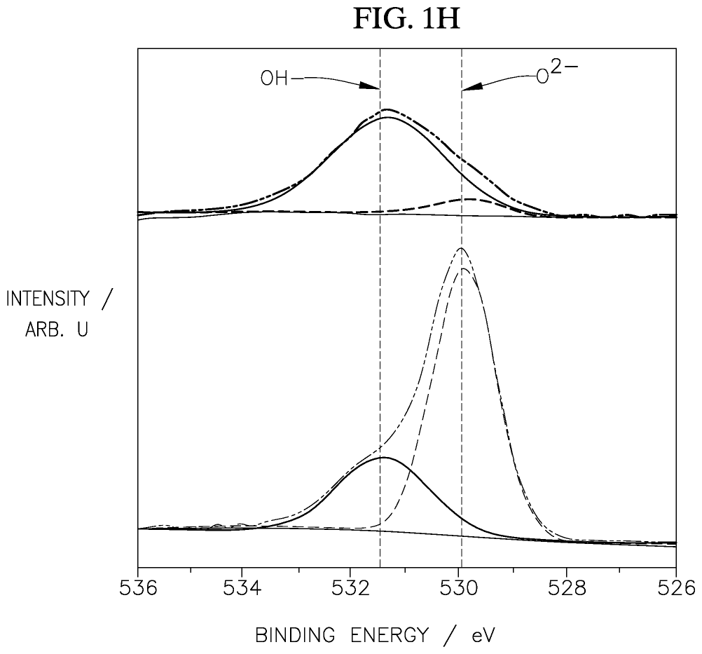

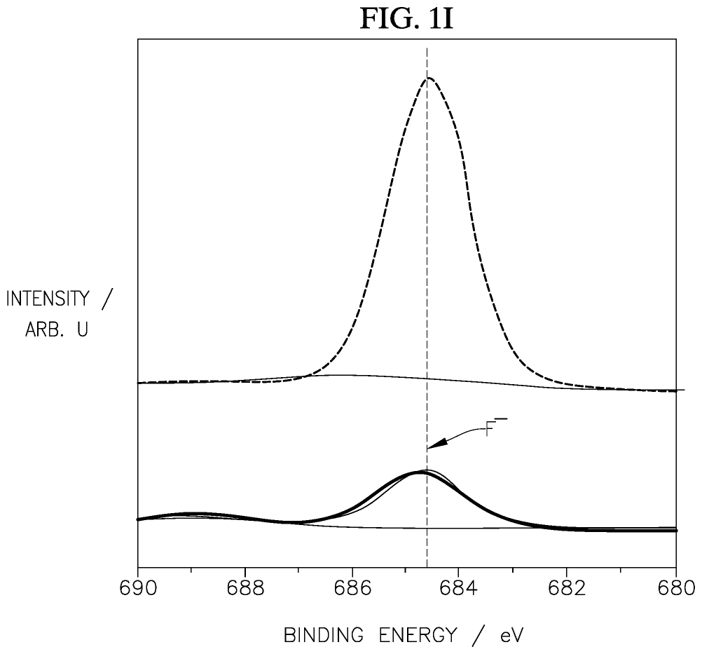

The fabrication procedure for producing a nanoporous oxide layer on stainless steel, which helps immobilize the lubricating and corrosion-resistant liquid (oil) in the empty space (nanopores), is shown in FIG. 1A. The anodizing performed by an ethylene glycol-based solution (7.5 g/l NH₄F+2.0 g/l water) resulted in the formation of yellowish film (FIG. 1B-I) on the stainless steel. However, the as-anodized film is soluble in water (FIG. 1B-II) and subject to potential damage by moisture and condensation of water. Annealing of the anodized stainless steel resulted in a change of the color from yellowish to deep brown (FIG. 1C-I). The deep brownish layer is insoluble in water and irremovable in rinsing by water (FIG. 1C-II), indicating the annealing process contributes to forming a stabilized anodic layer on the stainless steel. Black scale bars in FIGS. 1B and 1C indicate 1 cm. FIGS. 1D-G show the high-resolution X-ray photoelectron spectroscopy (XPS) spectra of O 1 s, F 1 s, Fe 2p3/2, and Cr 2p3/2, respectively, for the anodized stainless steel surfaces without and with annealing.

The O is spectra (FIG. 1D) have been deconvoluted into two peaks of O²⁻ (˜529.9 eV) and OH⁻ (˜531.4 eV) corresponding to oxides and hydroxides, respectively. The single peak (˜684.6 eV) in F 1s spectra (FIG. 1E) corresponds to fluorides. The spectra of Fe 2p3/2 (FIG. 1F) have been deconvoluted into two peaks corresponding to Fe (III) oxidation states with oxide (or fluoride at ˜711.0 eV) and hydroxide (at ˜713.8 eV). The spectra of Cr 2p3/2 (FIG. 1G) showed two peaks related with Cr (III) oxide (or fluoride at ˜576.2 eV) and hydroxide (˜578.3 eV);

The annealing resulted in a significant impact on the O 1 s and F 1 s spectra, while it showed a negligible effect on the Fe 2p3/2 and Cr 2p3/2 spectra. Due to the annealing, the O²⁻ peak (˜529.9 eV, corresponding to metal (Fe or Cr) oxides) for the anodized layer is significantly enhanced (area ratio (O²⁻/OH⁺): 0.11→2.65) with an increase in the chemical composition of oxygen (21.2→50.8 at. %), while the peak for OH− (531.4 eV, corresponding to metal (Fe or Cr) hydroxides) decreased. In contrast, the annealing resulted in a significant decrease of the intensity for the F− peak (˜684.6 eV, corresponding to fluorides) with a decrease in the chemical composition of fluorine (15.2→2.5 at. %). These results indicate that the ammonium fluorometallates ((NH₄)₃CrF₆ and (NH₄)₃FeF₆, yellowish film), which are highly soluble in water, are initially formed by anodizing in the ethylene glycol based solution, and then transformed to insoluble metal oxides (Fe₂O₃ and Cr₂O₃, deep brownish film) during the annealing in the ambient. In addition, from the fact that the F⁻ peak is found on the annealed anodized stainless steel with other peaks for OH⁻ (˜531.4 eV) and metal hydroxides (Fe³⁺ (˜713.8 eV) and Cr³⁺ (˜578.3 eV)), insoluble Fe(III) and Cr(III) hydroxide-hydroxyfluoride compounds can be included in the oxide layer. As a result, the anodizing in the ethylene glycol-based solution followed by post-annealing enables the fabrication of a stable oxide layer on the stainless steel.

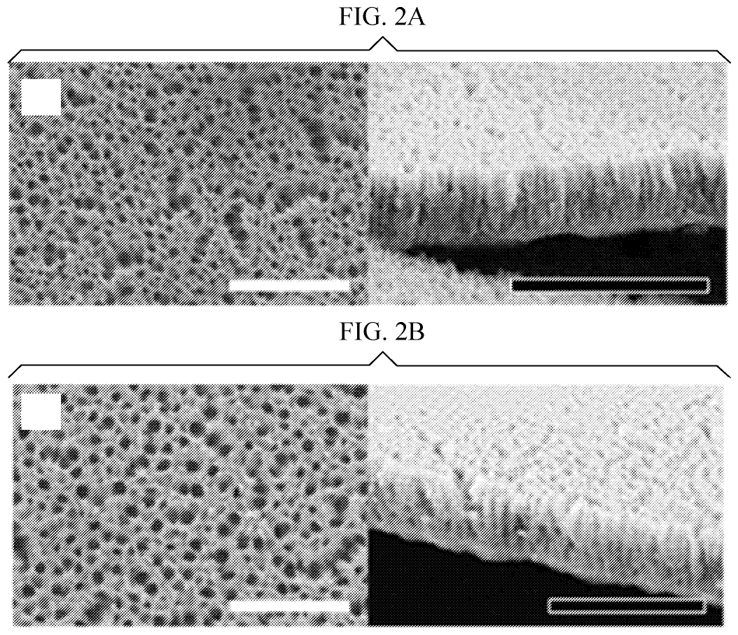

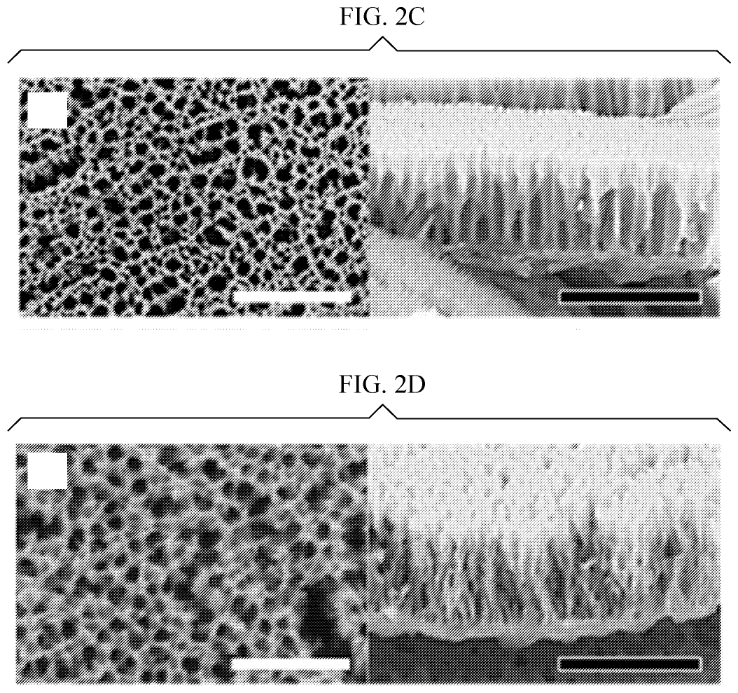

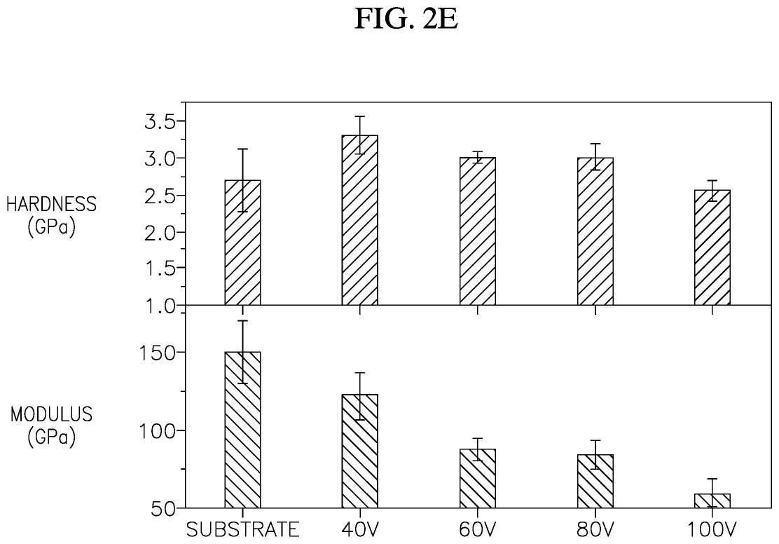

FIGS. 2A-D show the nanopore structures of the oxide layer anodized under different voltages (40, 60, 80 and 100 V, respectively) for 10 min followed by annealing. White and black scale bars in FIGS. 2A-2D indicate 0.5 and 1 μm, respectively. In the cases of 40, 60 and 80 V, the pores show a disconnected high-aspect-ratio dead-end cylindrical morphology, whereas interconnected porous networks were formed in the case of 100 V. The higher anodic voltage resulted in a larger diameter of pores (i.e., porosity) with a thicker oxide layer. The higher porosity contributes to a decrease of hardness and modulus of the oxide layer (FIG. 2E). However, the nanoporous oxides anodized at 40, 60 and 80V were still harder than that of the stainless steel substrate by 24%, 13% and 12%, respectively, while the oxide layer anodized at 100 V shows a lower value by 5%. In this study, the oxide layer anodized at 80 V, which has the largest porosity while still maintaining the disconnected cylindrical pore geometry with comparable hardness to the original stainless steel, was employed for the oil impregnation. Before oil impregnation, a thin layer of PTFE coating with a thickness of ˜2 nm, which shows a negligible effect on the morphology of nanopore structures, was applied to improve the chemical affinity of perfluorinated oils (Krytox GPL 100 and 1506) to the nanostructured surface.

### Example 2

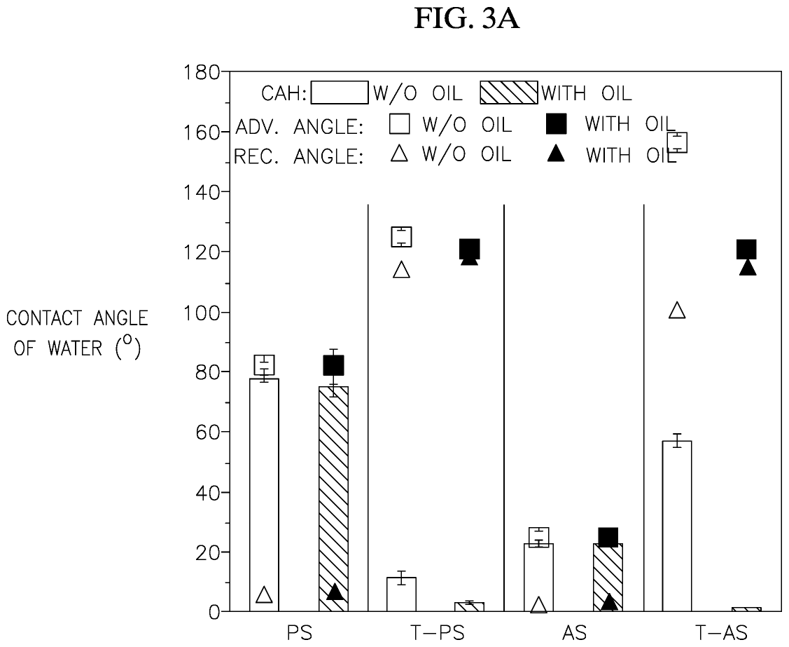

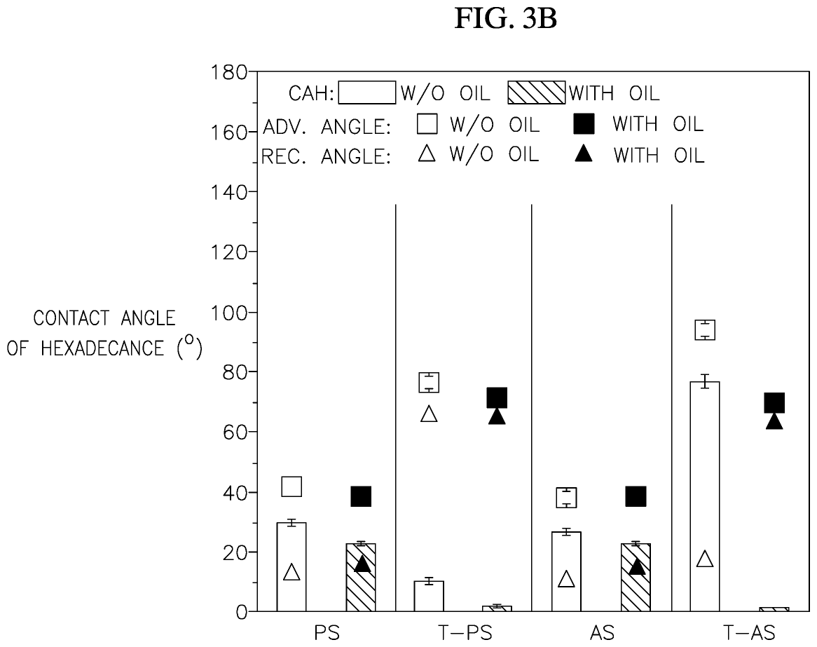

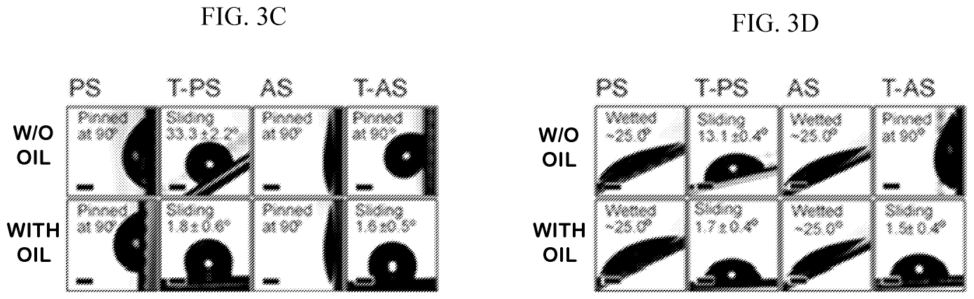

Wetting and mobility of a droplet (˜5 μl) for water (γ=72 mN/m) and hexadecane (γ=20 mN/m) were characterized on the anodized stainless steel surfaces before and after the PTFE coating and also oil impregnation. The surfaces without PTFE coating such as electropolished stainless steel (namely, PS) and anodized stainless steel (namely, AS) show high contact angle hysteresis (CAH) for both water and hexadecane droplets (see FIGS. 3A and 3B). A water droplet was pinned on the surfaces even with vertical (90°) inclination, while the hexadecane droplet began to move at ˜25° inclination while leaving a wetted trail behind due to the lower surface tension than that of water. The PTFE coating on PS (namely, T-PS) resulted in the decrease of the CAH so that the droplets slid at 33.3±2.2° and 13.1±0.4° for water and hexadecane, respectively (See FIGS. 3C and 3D, wherein Black scale bars indicate 1 mm). In contrast, while the PTFE coating on AS (namely, T-AS) increased the hydrophobicity more significantly than on PS, it did not decrease, but rather increased the CAH of the droplets due to the increase of the effective contact line along the continuous pore boundary of the nanopore structures, making the droplet less mobile. Thus, the water and hexadecane droplets are both pinned on the surfaces of T-AS, even with a vertical (90°) inclination. The oil impregnation with the hydrophilic surfaces (PS and AS) failed to enhance the mobility of the droplets on the surfaces, showing the similar CAH and sliding angle (SA) values of the surfaces without oil impregnation. Such ineffectiveness of the oil impregnation is attributed to the insufficient chemical affinity between the perfluorinated oil and hydrophilic surfaces, allowing the deposited liquid droplets to contact the solid surface. In contrast, the oil impregnation for PTFE-coated surfaces (T-PS and T-AS) resulted in dramatic enhancement of droplet mobility. The sufficient affinity between the perfluorinated oil and the PTFE-coated surface makes the nanopore structures retain oil stably, which inhibits the direct wetting of the liquid droplets to the solid surface, regardless of the surface tensions of droplets. Then, the droplets effectively sit on the liquid oil layer with little pinning, indicated by the significantly low CAH (less than ˜2°) and SA (less than ˜2°) regardless of the surface tensions of droplets (i.e., omniphobicity). Although the top oil layer on the T-PS with shallow nanodimples (˜1 nm deep) makes the droplets have the similar initial wettability and mobility on the surface compared to those on the T-AS with high-aspect-ratio (˜10) nanopores, such similarity in the initial wetting and mobility of droplets does not guarantee a similar stability or durability of the oil layer in dynamic conditions.

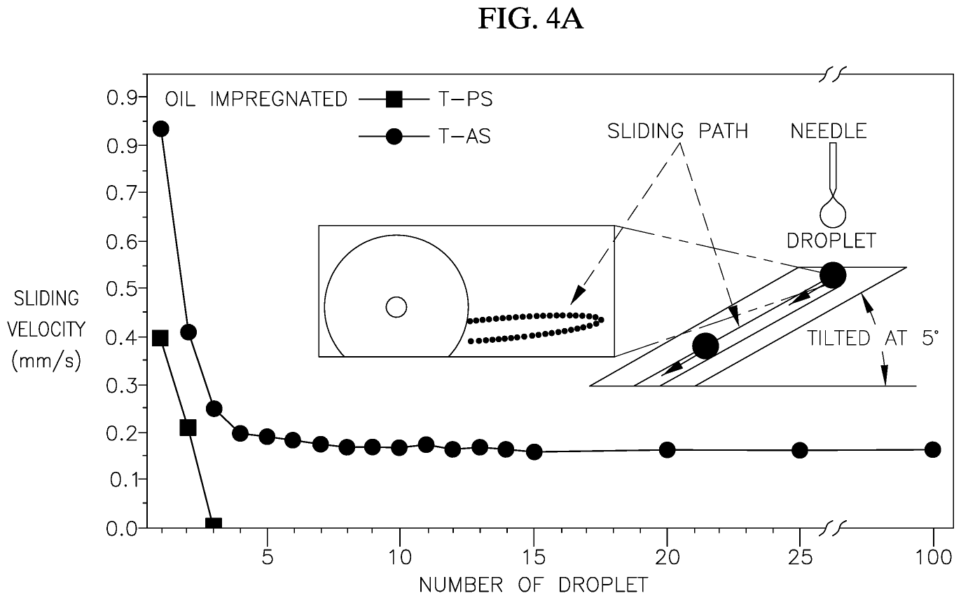

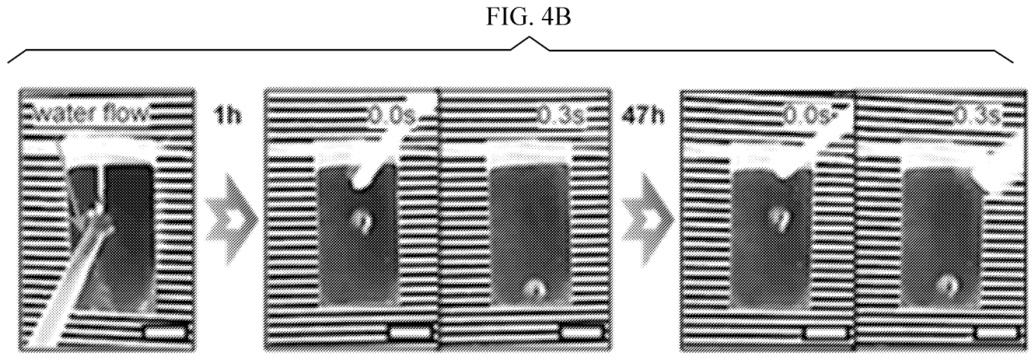

The depletion of oil from the nanostructured surfaces can compromise the initial omniphobicity of the oil-impregnated T-PS and T-AS (namely, O-T-PS and O-T-AS, respectively). To investigate the stability of the oil impregnated within the shallow nanodimples (T-PS) and cylindrical nanopores (T-AS), the sliding velocities of sessile water droplets (˜5 μl) continuously deposited on the same location on the surfaces were measured (FIG. 4A). Due to the strong capillary force maintaining the oil inside of the nanoscale high-aspect-ratio dead-end pores of the anodized oxide layer, T-AS is more effective in retaining a thicker oil layer under the sliding water droplets than T-PS having shallow dimples (˜1 nm deep). Therefore, the O-T-AS shows a higher sliding velocity of the first water droplet than the O-T-PS, although both show the similar sliding angle (less than ˜2°). The movement of water droplets results in the shearing and redistribution of the oil layer on the surfaces, as indicated by the track marked by the sliding droplet (inside image in FIG. 4A), which leads to the decrease of the sliding velocity with increasing numbers of the deposited water droplets. The O-T-PS shows a quick decay of the sliding velocity (i.e., pinning occurs from the third droplet), implying that the shallow dimples (˜1 nm deep) cannot effectively immobilize the oil on the surface, but allow the contact of water droplets to the solid surface. In contrast, the sliding velocity of the water droplets on O-T-AS was constant at ˜0.2 mm/s without any pinning, even when the number of droplets increased up to 100. Furthermore, the O-T-AS surface shows the robust non-wettability and slipperiness of water even under continuous flow of a water jet for more than 48 h (FIG. 4B), while the wetting and pinning of water on the T-AS without oil impregnation were observed even within a few seconds of the water jet flow. These results suggest that the disconnected high-aspect-ratio (˜10) cylindrical dead-end nanoscale pores realized for the surface of stainless steel are advantageous for immobilizing the oil within the nanostructures even against the applied shear flow causing the redistribution of oil layer by the capillary suction.

### Example 3

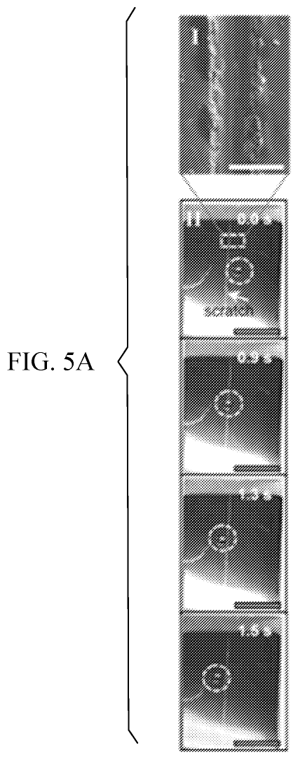

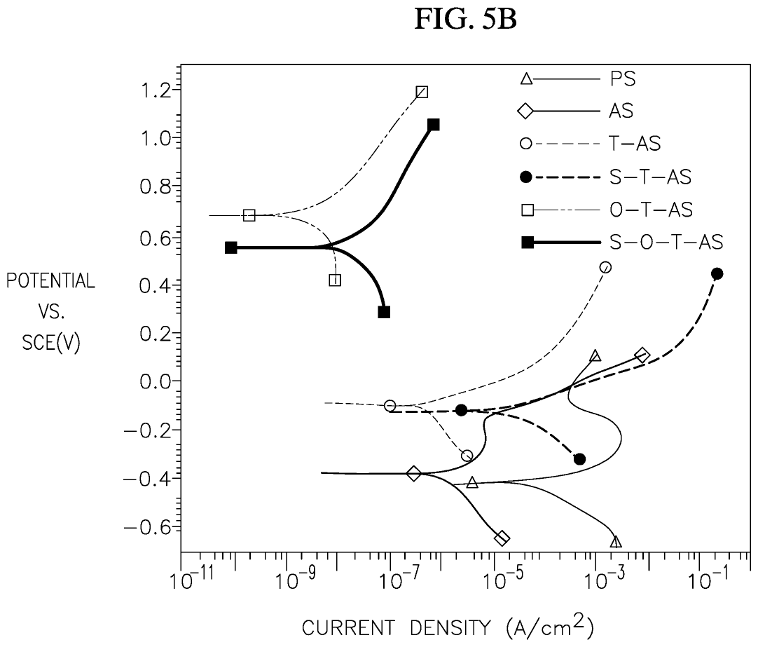

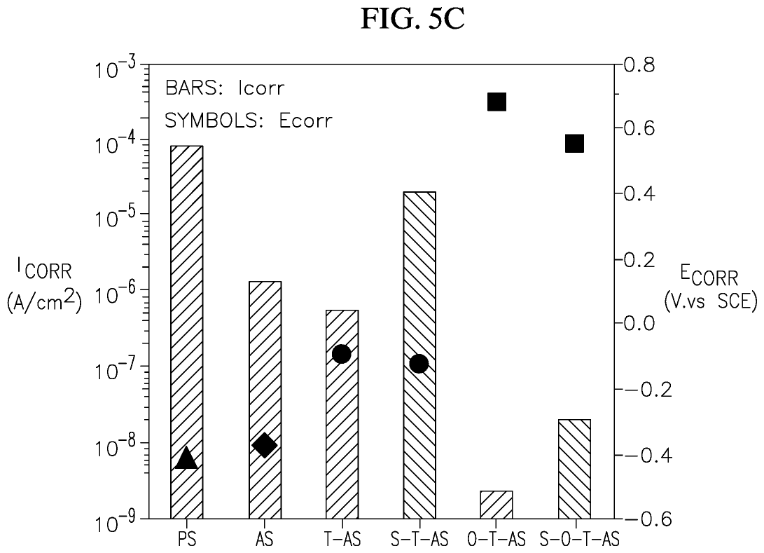

The fluidity of the oil retained well within the nanopores structures and allows self-healing capability against damage by overflowing and covering the exposed area. As shown in FIG. 5A, despite the presence of local defects, such as scratch by a razor blade, a water droplet is still mobile on the O-T-AS surface (˜5° inclination). White and gray scale bars in (A) indicate 20 μm and 1 cm, respectively. Such a great tolerance against damages or defects is one of the design considerations concerning the durability of omniphobic surfaces in practical applications subject to corrosion, as shown in FIGS. 5B and 5C. The hydrophilic AS easily gets wet by the chloride-containing corrosive solution within the pores, showing a rapid increase of current density in the potentiodynamic polarization test over the potential of ˜0.156 V. In contrast, the T-AS shows a higher corrosion potential and a lower corrosion current density than those of the hydrophilic AS and PS, since the T-AS renders a Cassie-Baxter wetting state for water (i.e., with air impregnated within the nanopores as a passivation layer). Moreover, the O-T-AS shows the greatest increase in the corrosion potential along with the commensurate decrease in the corrosion current density, which is two orders of magnitude lower than that of AS and T-AS, and four orders of magnitude lower than that of the PS. The results indicate that the O-T-AS have an exceptional corrosion resistance (inhibition efficiency: 99.99%). The durable omniphobicity of O-T-AS layers completely separates the corrosive media from the underlying stainless steel substrate, so that the O-T-AS layer can serve as a robust barrier that prevents a corrosion of stainless steel from chloride ions in the liquid. Moreover, due to the self-healing capability of the O-T-AS, the corrosion current density of the scratched O-T-AS (namely, S-O-T-AS in FIGS. 5B and 5C) was increased no more than by a factor of 8, whereas that of the scratched T-AS (namely, S-T-AS in FIGS. 5B and 5C) increased by more than 36 times. Meanwhile, in comparison to other intact surfaces including PS, AS and T-AS, the S-O-T-AS still shows the significantly higher corrosion potential and lower current density in the tested potential ranges due to the effective self-healing property.

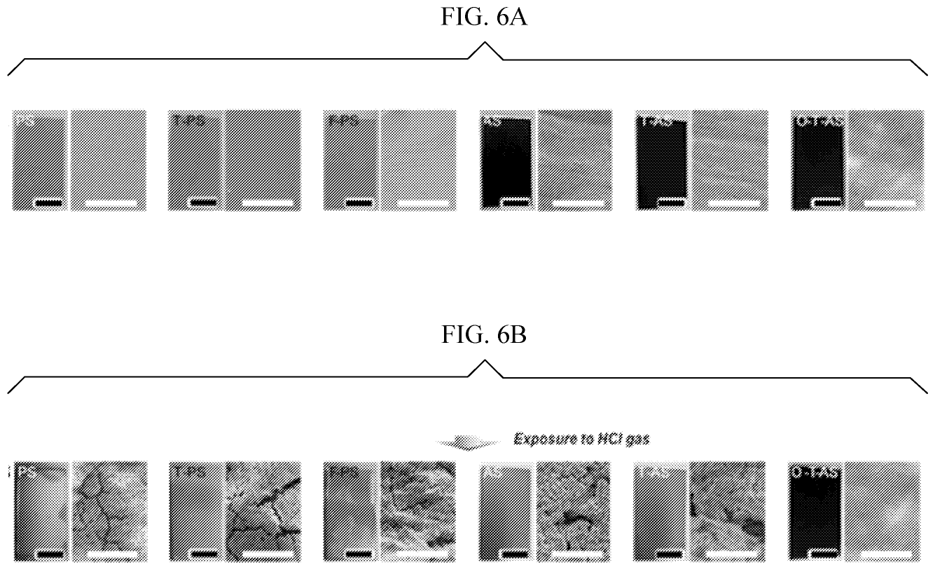

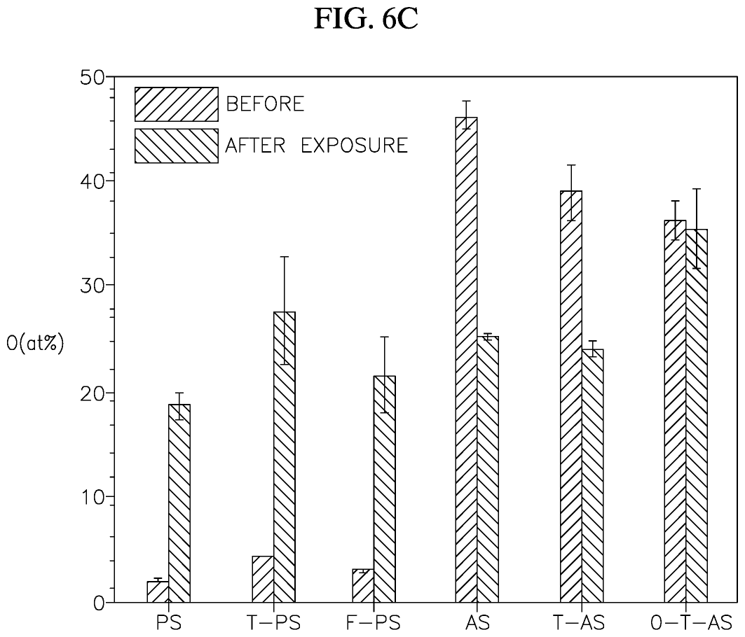

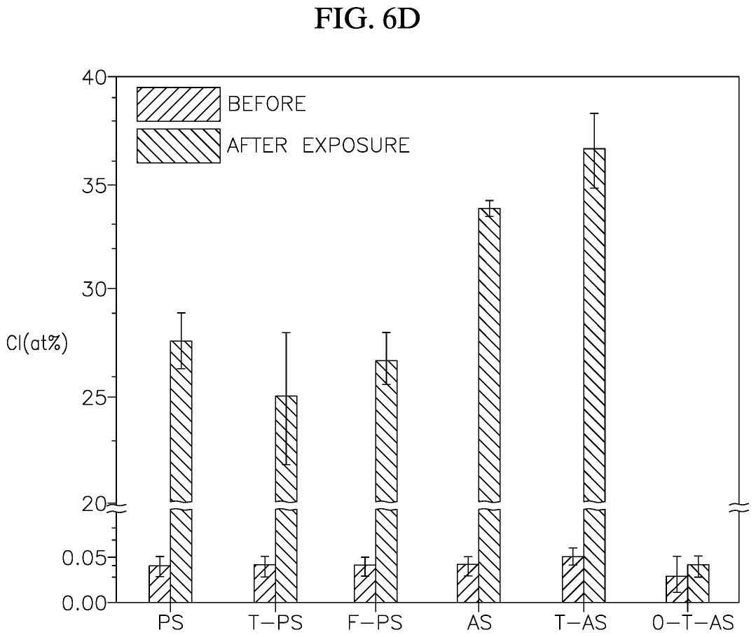

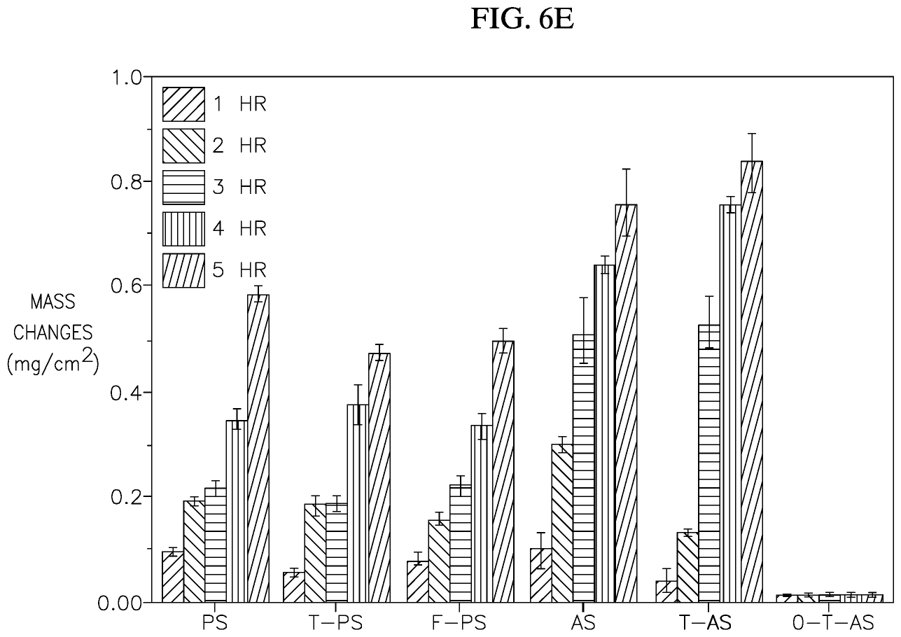

Corrosion resistance of the O-T-AS (impregnated with Krytox 1506 having low vapor pressure) in an atmospheric condition was tested, where the HCl gas in a vapor phase can corrode the surface. To minimize the weight change by the evaporation of oil during the test, Krytox 1506 with a low vapor pressure (4×10⁻⁷ torr at 20° C.), as opposed to Krytox GPL 100 with a high vapor pressure (1.92×10⁻³ torr at 20° C.), was used for the oil impregnation for the specimens. Due to the formation of rust by the atmospheric corrosion (see and compare the SEM images in FIGS. 6A and 6B), which can be confirmed by the increase in the concentration of oxygen (FIG. 6C) and chlorine (FIG. 6D) on the surface and also the weight gain with the exposure time (FIG. 6E), the surface appearances of PS, T-PS, and F-PS (polished stainless steel surface with hydrophobic coating of FDTS (perfluorodecyltrichlorosilane), as an alternative to PTFE) have changed to be a light brown color. Black and white scale bars in FIGS. 6A and 6B indicate 1 cm and 5 μm, respectively. The results indicate that the thin layer of hydrophobizing coating (either PTFE or FDTS) cannot protect the stainless steel from the corrosive acidic gas. The exposure to the HCl gas also corroded the surface of AS and T-AS with a change of a color from initial dark brown to light brown, which suggests a formation of metallic chlorides, destroying the nanoporous oxide layer to be a rust layer. Due to the larger surface area of a nanoporous layer, T-AS and AS show a high concentration of chlorine and hence the increase in the rate of mass change, compared to the surfaces with shallow nanodimples (PS, T-PS and F-PS). In addition, as the nanoporous oxide of AS or T-AS is converted to chloride during the corrosion, the concentration of oxygen decreases with the increase of chlorine. Although the hydrophobic nanoporous oxide layer without oil impregnation (i.e., T-AS) was effective as a barrier layer for the case of a corrosive liquid as shown in FIGS. 5B and 5C (inhibition efficiency: 99.32% in 1 M HCl solution) due to the air void retained within the hydrophobic pore structures (i.e., Cassie-Baxter state), it should be noted that the surface is unable to inhibit the transportation of vaporized corrosive media toward the metallic substrate in the case of atmospheric environment. This result indicates that the anti-corrosion strategy using a mere hydrophobic porous surface on metallic material has a critical drawback in environments where the corrosive media is presented as airborne so that its applicability should be carefully reconsidered. In contrast, the O-T-AS exposed to the HCl gas shows negligible differences in the chemical compositions of the oxide layer as well as the mass with no rust formation on the surface. These results indicate that the perfluorinated oil impregnated onto the nanoporous surface would not allow the permeation of corrosive media even in the vapor phases, protecting both the nanoporous oxide layer and underlying stainless steel substrate. Providing the exceptional anticorrosion property in not only corrosive liquids but also atmospheres, the omnicorrosion resistance of the oil-impregnated omniphobic surface is the most distinguished property compared to the hydrophobic or superhydrophobic surfaces for the corrosion protection strategies. Such advanced understanding is of great significance, illustrating that the anti-atmospheric-corrosion should also be critically considered in the design and application of water-repellent surfaces and that the oil-impregnated surfaces should be more advantageous against superhydrophobic surfaces.

### Example 4

In order to fully impregnate lubricant into the high-aspect-ratio dead-end nanopores of the anodized oxide layer of stainless steel, a solvent exchange method may be employed. First, the dried specimen with PTFE coating was immersed sequentially into ethanol and the solution known commercially as Vertrel XF™ (DuPont Inc.), a fluorocarbon fluid, for 10 min with ultrasonication, respectively. Then, the specimen wetted with Vertrel XF™ fluid, which is a solvent dissolving Krytox lubricants, was immersed into the Krytox lubricants (GPL 100 or 1506, DuPont) for 10 min with ultrasonication. It should be appreciated that the oil solvent (e.g., a fluorocarbon fluid) can be substituted, dictated by the oil solvent's compatibility with the chosen lubricant. During this process, the temperature of liquids was maintained at 25° C., and the specimen was transferred between solvents with no drying. The excessive lubricant left on the specimen after the completion of the solvent exchange process was removed by blowing with compressed air.

### Example 5

### Preparation

For a stainless steel substrate, AISI 304 (Fe-18Cr-8Ni, Alfa Aesar) sheet with 0.1 mm in thickness was employed. It was cut into 45 mm×20 mm in size and used for a specimen. The specimen was degreased in acetone with ultrasonication for 3 min. Before anodizing, the surface of stainless steel was electropolished in a mixture of percholoric acid and ethylene glycol (1:19 volumetric ratio) under voltage of 40 V for 5 min at 10° C.

To anodize the stainless steel, ethylene glycol based electrolyte was employed for the anodizing in order to build up a nanoporous oxide layer on the stainless steel. Anodic voltages (40, 60, 80, and 100 V, respectively) were applied on the stainless steel for 10 min in the ethylene glycol based solution (1.5 g of NH₄F and 0.4 g of water in 200 mL of ethylene glycol) at 5° C. After the anodizing, the residual electrolyte on stainless steel was removed with acetone. Then the specimen was annealed on a hotplate at 350° C. for 1 h.

Next a polytetrafluoroethylene (PTFE) coating was applied. For polytetrafluoroethylene (PTFE) coating, which is applied to improve the affinity between the nanoporous oxide surface and fluorocarbon lubricants (e.g., Krytox 100 and 1506, DuPont), PTFE (DuPont) was coated on the specimen. It should, however, be appreciated that in principle, alternate hydrophobic chemicals could be used for the PTFE, with such chemicals ideally being hydrophobic (water-repellant, water immiscible and non-corrosive) and oleophilic (having high chemical affinity to the chosen lubricant oil). Before the PTFE coating, O2 plasma (Harrick plasma) treatment was conducted for 15 min to remove organic residues on the surface. Then, the specimen was cleaned with both acetone and ethanol for 10 min, and rinsed in deionized water with ultrasonication for 5 min. Residual water on the surface was dried on a hotplate at 150° C. for 10 min. The specimen was then coated with 0.2 wt % PTFE solution (a mixture of PTFE AF1600 powder in fluorocarbon-compound FC-40, Acros) by spin-coating at 300 rpm for 30 s at room temperature, which resulted in the PTFE film thickness of around 2 nm. To evaporate the solvent, the sample was baked on a hotplate at 110° C. for 10 min, and 165° C. for 5 min. Further heat-treatment was applied for the improvement of adhesion at 330° C. for 15 min.

The next step was lubricant impregnation. In order to fully impregnate lubricant into the high-aspect-ratio, dead-end nanopores of the anodized oxide layer of stainless steel, a solvent exchange method was employed. First, the dried specimen with PTFE coating was immersed sequentially into ethanol and Vertrel XF™ fluid (DuPont Inc.) for 10 min with ultrasonication, respectively. Then, the specimen wetted with Vertrel XF™ fluid, which is a solvent dissolving Krytox lubricants, was immersed into the Krytox lubricants (GPL 100 or 1506, DuPont) for 10 min with ultrasonication. During this process, the temperature of liquids was maintained at 25° C., and the specimen was transferred between solvents with no drying. The excessive lubricant left on the specimen after the completion of the solvent exchange process was removed by blowing with compressed air.

In order to characterize the obtained material, the surface chemical state of the anodized stainless steel was analyzed by X-ray photoelectron spectroscopy (XPS, Sigma Probe, Thermo Scientific) using Al Ka (1486.6 eV). The porous structure of the anodized oxide layer was also observed using field emission scanning electron microscope (FE-SEM, Quanta FEG 450, FEI). Hardness and modulus of the anodized oxide layer were measured using a nano-indentation tester (TTX-NHT, CSM Instruments) with the Oliver & Pharr method.

To characterize the wettability and mobility of liquid droplets on a specimen, the apparent contact angle, contact angle hysteresis, and sliding angle of a sessile droplet (˜5 μL) of deionized water (surface tension at room temperature, γ=72mNm⁻¹) and hexadecane (γ=20 mN m⁻¹) were measured using a goniometer system (Model 500, Rame-hart). To measure the velocity of a sliding water droplet on the lubricant-impregnated surfaces, a sessile water droplet (˜5 μL) was gently deposited on the preinclined (˜5°) surface. Then, the sliding motion of a water droplet was recorded using the goniometer system. The velocity of the sliding water droplet was calculated for the time to slide by 5 mm. The durability of the surface wettability and droplet mobility was investigated with a continuous water flow (1 L min⁻¹) applied onto the surfaces preinclined at ˜5°, using a tube with 6 mm diameter.

Corrosion resistance of the specimen in liquid environment was evaluated by potentiodynamic polarization testing in 1 M HCl solution at room temperature using a Solatron moduLab system (Solatron Analytical Company). Platinum mesh and saturated calomel electrode were used for counter and reference electrodes, respectively. Prior to the test, each specimen was immersed in the electrolyte for 20 min to reach a steady state of open circuit potential (OCP). The potential was scanned from −300 to 1000 mV vs. OCP with 2 mV s⁻¹ rate. For the test in corrosive atmosphere, 100 mL of high concentration (37%) of HCl solution was placed at the bottom of desiccator at room temperature. Then, the specimen was placed on a punched plate in the desiccator. To minimize the evaporation of lubricant which would potentially affect the accuracy of the measurement of the weight change during the corrosion process, a vacuum-grade fluorocarbon lubricant Krytox 1506 having low vapor pressure (4×10⁻⁷ torr at 20° C.), instead of Krytox GPL 100 having high vapor pressure (1.92×10⁻³ torr at 20° C.), was impregnated in the PTFE-coated anodized nanoporous oxide layer of stainless steel during the atmospheric corrosion test. The mass change of the specimen by the atmospheric corrosion was measured using a high precision balance (resolution: 0.1 mg, Mettler Toledo). Chemical composition of the corroded surfaces was analyzed using focused ion beam (FIB) SEM (Zeiss Auriga) with EDS (energy dispersive spectroscopy).

### Verification

For the fluorocarbon lubricant impregnated nanoporous oxide (FLINO) coating, a stable nanoporous oxide should be first prepared on the surface of stainless steel followed by the surface modification with low surface energy polytetrafluoroethylene and the impregnation of fluorocarbon lubricant (FIG. 1A). The stainless steel plate can be anodized in ethylene glycol-based solution (7.5 g L⁴ NH₄F+2.0 g L⁻¹ water) resulting in a yellowish film (FIG. 1B). Since the as-anodized structure of stainless steel is soluble in water, the film can be easily removed by moisture and/or condensation of water). This instability issue can be resolved by simple thermal annealing. After annealing at 350° C. for 1 h, the film becomes dark brown color and irremovable with water (FIG. 1C). This change of film by annealing was characterized by high-resolution X-ray photoelectron spectroscopy (XPS) spectra of O 1 s, F 1 s, Fe 2p3/2, and Cr 2p3/2 before and after annealing (FIGS. 1H and 10. The annealing caused significant variations in the O 1s and F 1s spectra while it showed a negligible effect on the Fe 2p3/2 and Cr 2p3/2 spectra. By annealing, the O²⁻ peak (˜529.9 eV, corresponding to metal (Fe or Cr) oxides) for the anodized layer is enhanced (area ratio (O²⁻/OH⁻): 0.11→2.65) with an increase in the chemical composition of oxygen gen (21.2→50.8 at. %) while the peak for OH⁻ (˜531.4 eV, corresponding to metal (Fe or Cr) hydroxides) decreased. In contrast, the annealing resulted in a decrease of the intensity for the F⁻ peak (˜684.6 eV, corresponding to fluorides) with a decrease in the chemical composition of fluorine (15.2→2.5 at. %). These results indicate that the ammonium fluorometallates ((NH₄)₃CrF₆ and (NH₄)₃FeF₆, yellowish film), which are highly soluble in water, are initially formed by anodizing in the ethylene glycol based solution, and then transformed into insoluble metal oxides (Fe₂O₃ and Cr₂O₃, deep brownish film) during the annealing. In addition, the F⁻ peak is found on the annealed anodized stainless steel with other peaks for OH⁻ (˜531.4 eV) and metal hydroxides (Fe³⁺ (˜713.8 eV) and Cr³⁺ (˜578.3 eV)), indicating that insoluble Fe(III) and Cr(III) hydroxide-hydroxyfluoride compounds can be included in the oxide layer. As a result, the anodizing in the ethylene glycol-based solution followed by post-annealing enabled us to fabricate a stable nanoporous oxide layer on stainless steel.

The nanopore structures of the oxide layer anodized under different voltages (40, 60, 80 and 100 V) for 10 min followed by annealing (FIG. 2C). In the cases of 40, 60 and 80 V, the pores show disconnected high-aspect-ratio dead-end cylindrical morphology, whereas interconnected porous networks were formed under 100 V. The higher anodic voltage resulted in a larger diameter of pores (or porosity) with a thicker oxide layer. The higher porosity contributes to a decrease of elastic modulus of the oxide layer (FIG. 2E). However, the nanoporous oxides anodized at 40, 60 and 80 V are still harder than that of the stainless steel 304 substrate by 24, 13 and 12%, respectively, while the oxide layer anodized at 100 V shows lower value by 5%. In this study, the oxide layer anodized at 80 V, which has the largest porosity while still maintaining the disconnected cylindrical pore geometry with comparable hardness to the original stainless steel, was employed for the fluorocarbon lubricant impregnation. Before lubricant impregnation, the surface of the nanoporous structure was modified with a thin layer of PTFE (polytetrafluoroethylene, PTFE) with a thickness of ˜2 nm, which improves the chemical affinity of fluorocarbon lubricant (Krytox GPL 100 and 1506) to the nanostructured surface with a negligible effect on the dimension and morphology of the nano-pore structures.

Wetting and mobility of droplets (˜5 μL) of water (γ=72 mN m⁻¹) and hexadecane (γ=20 mN m⁻¹) on the anodized stainless steel surfaces before and after the PTFE coating were characterized by measuring a sliding angle (FIGS. 3C and 3D). For comparison with the anodized stainless steel (AS), electropolished stainless steel (ES) having shallow nanoscale dimples (˜1 nm deep) were also prepared and characterized in the same way. Contact angles of water and hexadecane droplets increased by the PTFE coating on both electropolished and anodized stainless steel. Particularly, water contact angle increased up to 146.0° in a Cassie-Baxter state on the PTFE-coated AS by nanoporous structures retaining air in the pores. However, water and hexadecane droplets are both pinned on the surfaces of the PTFE-coated AS even with a vertical(90°) inclination due to the increase of the effective contact line along the continuous pore boundary of the nanopore structures. The lubricant impregnation on the PTFE-coated surfaces (T-ES and T-AS) resulted in dramatic enhancement of the droplet mobility while the lubricant impregnation on the hydrophilic sur-faces (ES and AS) failed to enhance the mobility of the droplets on the surfaces. The sufficient affinity between the fluorocarbon lubricant and the PTFE-coated surface makes the stable lubricant layer on nanopore structures, which inhibits the direct wetting of the liquid droplets to the solid surface, regardless of the surface tensions (γ) of droplets. Then, the droplets effectively sit on the liquid lubricant layer without pinning, indicated by the significantly low sliding angle (less than) ˜2° regardless of the surface tensions of droplets (i.e., omniphobicity). Although the top lubricant layer on the T-ES with shallow nanodimples (˜1 nm deep) makes the droplets have the similar initial wettability and mobility on the surface compared to those on the T-AS with high-aspect-ratio (˜10) nanopores, such similarity in the initial wetting and mobility of droplets does not guarantee a similar stability or durability of the lubricant layer in dynamic conditions.

The depletion of fluorocarbon lubricant from the nanostructured surfaces diminishes the initial omniphobicity of the lubricant impregnated T-ES (namely, L-T-ES) and T-AS (namely, L-T-AS, which is FLINO). To investigate the stability of the lubricant impregnated within the shallow nanodimples (T-ES) and cylindrical nanopores (T-AS), the sliding velocities of sessile water droplets (˜5 μL) continuously deposited on the same location on the surfaces were measured (FIG. 4A). Due to the strong capillary force of the lubricant inside in the nanoscale high-aspect-ratio dead end pores of the anodized oxide layer, the T-AS is much more effective in retaining a thicker lubricant layer under the sliding water droplets than the T-ES having shallow dimples (˜1 nm deep).

Moreover, the L-T-AS (FLINO) with cylindrical nanopores shows a higher sliding velocity of the first water droplet than the L-T-ES with shallow nanodimples, although both show the similar sliding angle (less than ˜2°). The movement of a water droplet results in the shearing and redistribution of the lubricant layer on the surfaces, as indicated by the track marked by the sliding droplet (see the inset image in FIG. 4A), which leads to the decrease of the sliding velocity with the number of the deposited water droplet. The L-T-ES shows a quick decay of the sliding velocity (i.e., pinning occurs from the third droplet), implying that the shallow dimples (˜1 nm deep) cannot effectively immobilize the lubricant on the surface but allow the contact of a water droplet to the solid surface. In contrast, the sliding velocity of the water droplet on FLINO was constant at ˜0.2 mm s⁻¹ without any pinning although the number of droplets increased up to 100. Furthermore, the FLINO surface shows the robust non-wettability and slipperiness of water even under continuous flow of water jet for more than 48 h (FIG. 4B), while the wetting and pinning of water on the T-AS without lubricant impregnation were observed even within a few seconds of the water jet flow. These results suggest that the disconnected high-aspect-ratio (˜10) cylindrical dead-end nanoscale pores realized for the surface of stainless steel are advantageous for immobilizing the lubricant within the nanostructures. Therefore, the surface maintains slipperiness even against the applied shear flow which may cause the redistribution of the liquid lubricant layer and the exposure of the pinning sites of the underneath solid surface.

The fluidity of the lubricant retained well within the nanoporous structures allows self-healing capability against damages by overflowing and covering the exposed area. As shown in FIG. 5A, despite the presence of local defects such as scratch by a razor blade, the water droplet is still mobile on the FLINO surface (at ˜5° tilting). Such a great tolerance against damages or defects bolsters the durability of omniphobic surfaces in practical applications such as corrosion, as shown in FIGS. 5B and 5C. The hydrophilic AS easily gets wet by the chloride-containing corrosive solution within the pores, showing a rapid increase of current density in the potentiodynamic polarization test over the potential of −0.156 V. In contrast, the T-AS shows a higher corrosion potential and a lower corrosion current density than those of the hydrophilic AS and ES since the T-AS renders a Cassie-Baxter wetting state for water (i.e., with air impregnated within the nanopores as a passivation layer).

Moreover, the FLINO shows the highest corrosion potential along with the commensurate decrease in the corrosion current density, which is two orders of magnitude lower than that of AS and T-AS, and four orders than that of the ES. From those results, it is noted that the FLINO exhibits an outstanding corrosion resistance (inhibition efficiency: ˜99.99%). The durable omniphobicity of the FLINO layer completely separates the aqueous corrosive media (chloride ion) from the underlying stainless steel substrate. Moreover, due to the self-healing capability of the FLINO, the corrosion current density of the scratched FLING (namely, S-FLINO in FIGS. 5B and 5C) was increased no more than by a factor of 8, whereas that of the scratched T-AS (namely, S-TAS in FIGS. 5B and 5C) increased by more than 36 times. Meanwhile, the S-FLINO still shows the significantly higher corrosion potential and lower current density in the tested potential ranges in comparison to other intact surfaces, including ES, AS and T-AS, due to the effective self-healing property.

In previous work, it was reported that the hydrophobized chemical affinity to fluorocarbon lubricant and the disconnected high-aspect-ratio dead-end nanopore geometry are important for lubricant-impregnated porous surfaces to attain the durable omniphobicity and self-healing capability. However, it should be noted that it was demonstrated for light metal such as aluminum, which is one of the easiest metallic materials to form such nanoporous geometry based on anodizing processes. Fabrication approaches to realize the nanoporous oxide structures for hard metals such as stainless steel have not yet been systematically explored. One of the significances of the present invention is that the disconnected high-aspect-ratio dead-end nanopore oxide layer has been realized on the hard metal surface of stainless steel by employing the anodic oxidation process in ethylene glycol-based solution followed by the post-annealing process. This is quite a distinct approach from the conventional anodizing processes of light metal such as aluminum. Stainless steel is arguably the most popular and essential metal material employed in many applications subject to various wet and dry conditions. Thus, the development of material processing technology to fabricate durable nanoporous oxide structures on stainless steel is of great significance to surface finish and functionalization. Moreover, the fabrication processes based on general anodizing and annealing (or heat-treatment) are commercially or readily available with advantages in cost efficiency and mass production.

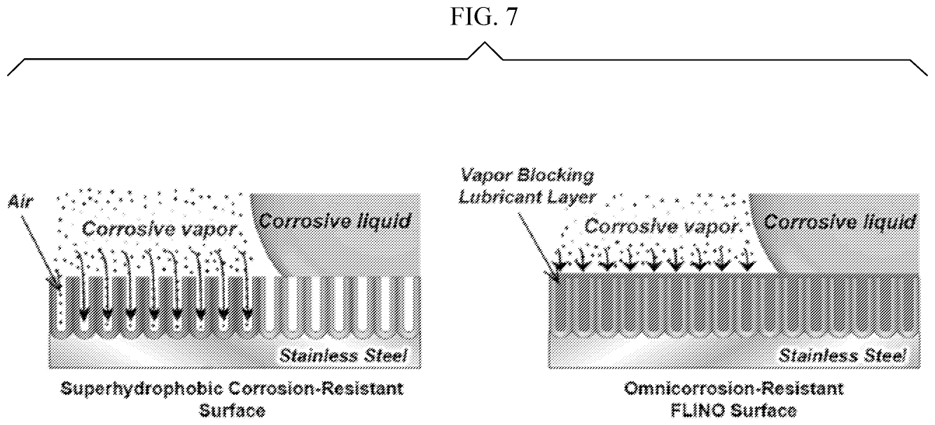

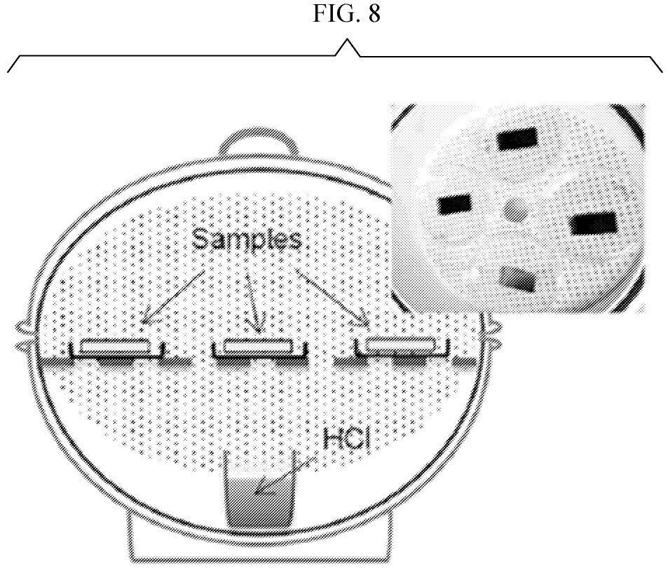

The corrosion resistance of the FLINO in an atmospheric condition where the HCl gas can corrode the surface was also tested (FIGS. 7 and 8). Since the Krytox GPL 100 has a volatilization issue in long-term test, the less volatile Krytox 1506 (volatility: 6.5% at 121° C. in 22 h, vacuum pump grade lubricant) was employed for FLINO in the atmospheric corrosion test. Due to the atmospheric corrosion, which can be confirmed by the increase in the concentration of oxygen (FIG. 6C) and chlorine (FIG. 6D) on the surface and also the weight gain with the exposure time (FIG. 6E), the surface appearances of ES and T-ES have changed to be a light brown color (see and compare the optical and scanning electron microscope (SEM) images in FIGS. 6A and 6B). The results indicate that the thin layer of hydrophobizing coating (PTFE) cannot protect the stainless steel from the corrosive acidic gas. The exposure to the HCl gas also corroded the surface of AS and T-AS with a change of a color from initial dark brown to light brown, which suggests a formation of metallic chlorides, destroying the nanoporous oxide layer and causing to become a rust layer. Due to the large surface area of a nanoporous layer, T-AS and AS show a high concentration of chlorine and hence, an increase in the rate of mass change, compared to the surfaces with shallow nanodimples (ES and T-ES). In addition, as the nanoporous oxides of AS and T-AS are both converted to chloride during the corrosion, the concentration of oxygen decreases with the increase of chlorine. Although the hydrophobic nanoporous oxide layer without lubricant impregnation (i.e., T-AS) was effective as a barrier layer for the case of a corrosive liquid as shown in FIGS. 5B and 5C (inhibition efficiency: 99.32% in 1 M HCl solution) due to the air void retained within the hydrophobic pore structures (i.e., Cassie-Baxter state), the surface is unable to inhibit the transportation of vaporized corrosive media toward the metallic substrate in the case of atmospheric environment. This result indicates that the anti-corrosion strategy using a mere hydrophobic porous surface on metallic material has a critical drawback in environments where the corrosive media is presented as airborne so that its applicability should be carefully reconsidered. In contrast, the LT-AS exposed to the HCl vapor shows negligible differences in the chemical compositions of the oxide layer as well as the mass with no rust formation on the surface.

The fluorocarbon lubricant impregnated into the nanoporous oxide does not allow for the permeation of corrosive media even in the vapor phase, protecting both the nanoporous oxide layer and underlying stainless steel substrate. As such, the exceptional anticorrosion property is provided not only in corrosive liquids but also in atmospheres. The omnicorrosion resistance of the FLINO is a notable property compared to other corrosion protection strategies, such as superhydrophobic coating. The omniphobic and omnicorrosion-resistant properties of the lubricant-impregnated nanoporous oxide layer of stainless steel with the great durability and self-healing capability will specifically be of great significance in real applications of stainless steel material under severe corrosive environments such as chemical plants, heat exchanger systems, seawater desalination, solar thermal applications, lubricant/gas industries, and marine systems, where the corrosive media can be transported via both liquid and vapor phases. The atmospheric corrosion resistance for the FLINO layer engineered on the other metal such as aluminium have also been tested and confirmed, indicating the general efficacy of the FLINO for omnicorrosion protection for metals.

Overall, the lubricant retained durably on the hydrophobized nanoporous layer significantly enhances the corrosion resistance of stainless steel by inhibiting the direct contact of corrosive media, both in liquid and vapor phases, resulting in omnicorrosion resistance required for real applications. It suggests that the surface engineering of FLINO for metals can be an alternative or more advantageous strategy than the other water-repelling surface modification approaches, such as superhydrophobic surface engineering, in realizing multifunctional surfaces, further featured with the unique omnicorrosion resistance. Moreover, the approach presented here (i.e., combination of nanoporous oxide and lubricant) would be of great importance in protective and multifunctional surface engineering for other metallic materials, with the merits of the scalability of the anodizing technique which has been widely used in manufacturing processes and industrial applications.

It will be understood that the embodiments described herein and in the attached Appendices are merely exemplary and that a person skilled in the art may make many variations and modifications without departing from the spirit and scope of the invention. All such variations and modifications are intended to be included within the scope of the invention described and illustrated herein.

1. (canceled)

2. A coating for stainless steel surfaces, comprising a layer of anodized steel, including a plurality of high-aspect-ratio, dead-end nanopores distributed throughout said layer of anodized steel such that each nanopore of said plurality of nanopores is isolated from every other nanopore of said plurality of nanopores, each nanopore of said plurality of nanopores having a respective pore volume and walls extending into said layer of anodized steel, said walls exhibiting hydrophobic properties, and each nanopore of said plurality of nanopores containing a volume of liquid oil substantially equal to said respective pore volume thereof, whereby said plurality of nanopores contains only said liquid oil which completely fills each nanopore while eliminating air therefrom.

3. The coating of claim 2, wherein said liquid oil is water-repellant.

4. The coating of claim 2, wherein said liquid oil is water immiscible.

5. The coating of claim 2, wherein said liquid oil is anti-corrosive.

6. The coating of claim 2, wherein said liquid oil is a perfluorinated oil.

7. The coating of claim 2, wherein said layer of anodized steel has an outer surface.

8. The coating of claim 7, wherein said outer surface of said layer of anodized steel has hydrophobic properties.

9. The coating of claim 7, wherein said outer surface of said layer of anodized steel has oleophilic properties.

10. The coating of claim 2, further comprising a hydrophobic/oleophilic coating provided on said walls of each nanopore of said plurality of nanopores.

11. The coating of claim 10, wherein said liquid oil is capable of filling surface defects in said hydrophobic/oleophilic coating.

12. The coating of claim 10, wherein said hydrophobic/oleophilic coating layer has low chemical affinity to water, but high chemical affinity to oil.

13. The coating of claim 10, wherein said hydrophobic/oleophilic coating layer comprises polytetrafluoroethylene.

14. The coating of claim 10, wherein said hydrophobic/oleophilic coating layer comprises perfluorodecyltrichlorosilane.

15. The coating of claim 2, wherein said walls of each nanopore of said plurality of nanopores include a sidewall and a dead-end, said sidewall cooperating with said dead-end to define a lumen within each nanopore of said plurality of nanopores.

16. The coating of claim 15, wherein said liquid oil completely fills said lumen of each nanopore of said plurality of nanopores.

17. The coating of claim 2, wherein said layer of anodized steel is annealed.

18. A coating for stainless steel surfaces, comprising a layer of anodized steel, including a plurality of nanopores distributed throughout said layer, each nanopore of said plurality of nanopores having walls exhibiting hydrophobic/oleophilic properties, and each nanopore of said plurality of nanopores containing a quantity of a filling solution, which is displaceable therefrom in response to the exposure of said plurality of nanopores to an oil solvent.

19. A method for forming a coating on a surface of a stainless steel substrate, said method comprising the steps of:
(i) anodizing said substrate in electrolyte to form an oxide layer having a plurality of nanopores, each nanopore having a wall;
(ii) annealing said oxide layer; and
(iii) filling said plurality of nanopores with a liquid oil.
